(19) United States
(12) Patent Application Publication
(10) Pub. No.: US 2018/0158439 A1
(43) Pub. Date: Jun. 7, 2018

(54) Dismountable stringed musical instrument with splitted fingerboard

(71) Applicant: Gionata Quercetani, Sant'llario d'Enza (IT)

(72) Inventor: Gionata Quercetani, Sant'llario d'Enza (IT)

(21) Appl. No.: 15/698,196

(22) Filed: Sep. 7, 2017

Related U.S. Application Data
(60) Provisional application No. 62/385,981, filed on Sep. 10, 2016.

(51) Int. Cl. G10D 1/02; G10D 3/06

(52) U.S. Cl. CPC G10D 1/02; G10D 3/003; G10D 3/06

(57) ABSTRACT

A dismountable stringed musical instrument with a splittable fingerboard and an acoustic sound is disclosed having a hollow body composed by two parts shaped as half empty shell that meets each other on their outer perimeter, defining a sound chamber. The fingerboard is splitted in two parts that can be re-assembled by a rigid inner core which works as a reinforcement and as a trail to allows the fingerboard cutted portions to slide on it meeting each other perfectly and by a latch toggle clamp which hold the two parts strictly merged together, taking back the fingerboard to its original playable smoothness. The neck can be dismounted to from the body and then re-assembled in the playing position also adjusting its inclination at will by movable elements placed on the neck extremity which faces the top portion of the body support area.

### CROSS REFERENCES TO RELATED APPLICATIONS

Claims benefits of a provisional application No. 62/385,981, filed on Sep. 10, 2017 entitled “Dismountable stringed musical instrument” which is hereby incorporated by reference.

### BACKGROUND OF THE INVENTION

The present invention relates generally to improvements of stringed musical instruments and, more particularly, to an easily transportable electric double bass while keeping the same sound quality and playing feel of a traditional acoustic double bass. The invention can be applied to various bowed stringed instruments belonging to the violin family such as cellos, violones, and other like stringed instruments. However, the invention is particularly advantageous when applied to an instrument such as a double bass. This specification is written to be understandable by any person who, at least, have already seen a bowed stringed instruments and who basically knows how it works to emit sounds following the musician action on the instrument itself. So, the most common parts of this type of instruments, and concepts like sound chamber or intonation, are taken for granted and assumed as a necessary basic knowledge to completely understand the description of the invention.

Transporting stringed musical instruments is an endeavor with many perils. This is especially true for stringed musical instruments like the double bass due to its size and fragility. The top, back, and sides are typically constructed of spruce and maple, usually not more than ⅜″ thick; the standard dimensions of a ¾ acoustic double bass (not the biggest size for this kind of instrument but still the most common) are approximately 74″ height×27″ width×25″ depth. Furthermore, the double bass is usually more expensive and, due to its fragility, a slight bump in the wrong place can cause the neck to snap completely off or to crack in some parts of the body (to take some quick examples), compromising the instrument's functionality and usability, requiring difficult, precise, specialized, and expensive repairs.

The first solution to the difficult transportation and safekeeping of the double bass is to carry it in a hard shell case. Unfortunately, hard cases are very expensive and at the same time very bulky. They are too bulky to fit comfortably in cars and, moreover, are typically larger than the limitations imposed by air lines concerning carry-on baggage. However, even if the instrument is allowed on the airplane, either as carry-on baggage or checked baggage (upon payment of expensive fees), damage to the instrument being transported in a hard shell case is rather common. Obviously, the problem cannot be solved using a soft bodied case: even though it can be less bulky, it cannot surely reduce the bulkiness of the double bass itself offering, regardless, inadequate protection for the instrument during travel, always at risk to be subjected to bumps. Furthermore, with heightened security measures at airports presently in effect, many airlines refuse to transport double basses at all.

A second solution is to rent an instrument at your destination. In addition to the expense of renting an instrument (usually not refunded to the musician), rental instruments are often of inferior quality, dissimilarly configured, and of unfamiliar setup or “feel”. Consider for example an international musician that, during an international tour of several dates, needs to rent a double bass at each location he plays: it becomes a big waste of time planning how and where to rent, ending up using a different instrument at each gig, all the while having to take on all rental costs and, obviously, having a bad effect on musician's performance.

Consequently, due the obvious impossibility of easy, quick, and economical transport of an acoustic double bass, the solution was to create an electric double bass, also named electric upright bass (EUB). In these instruments, the sounding body is replaced by a much smaller and less bulky solid body (or, sometimes, a “skeleton” body, made up only by the frame of the body) minimizing the elements necessary for a double bass that could be played by musicians trained on traditional double basses. The sound amplification functions are entrusted to electronic devices such as microphones or piezoelectric pickups positioned on or near the bridge. With this smaller and thinner body the instrument is surely less bulky laterally and much less heavy, but its height remains very hard to handle, so some prior art electric upright basses can be disassembled by breaking down the neck from the body, disassembling other elements like the tailpiece, or equipping the instrument with a telescopic endpin, to ease transportation. But all of these prior disassembling methods are stopped by the obstacle of the neck and fingerboard integrity: the fingerboard must be solidly attached to the neck, and the fingerboard is longer than the neck itself, so the fingerboard is the longest part of the instrument that can't be splitted or disassembled because the main and essential purpose of the fingerboard is to be perfectly smooth and without any junction points or gaps, to allows the musicians to play with the perfect and right intonation that they are able to do.

All these improvements allow the electric upright bass to fit in a smaller hard case, able to fit in turn into a car, for example.

Electric upright basses appear to be the final solution for double bassist allowing them to have instruments that could always be carried easily everywhere, but this solution makes the sound of the instrument poorer in tone and quality, less brilliant, warm, and “acoustic”, resulting in a sound that is very different from that of a real acoustic double bass. The sound is so different, that the electric upright bass became essentially a separate category of instruments, due its unique sound completely different from that of a real double bass in terms of feedback, brilliance, groove, sustain, tone and presence. Some electric upright basses have a small, hollow resonant chamber, but it isn't enough to fill the gap of sound quality compared to acoustic double basses.

Thus, what is needed is a stringed acoustical instrument that can be disassembled in an easy and fast way to become as small and as light as possible and that can be easily transportable by car, plane, and all other modes of transportation. All of these features are necessary without sacrificing sound quality, the playability, the musician's feel, and the authenticity of the sound.

However, no previous attempts completely solved the problem described above as well as the present invention.

### BRIEF SUMMARY OF THE INVENTION

This invention is directed at stringed musical instruments such as the double bass, cello, or similar stringed instrument to ensure easy transportability without losing sound quality, while still being able of being disassembled.

The instrument is able of being disassembled in four main parts: the fingerboard, the neck, the body and the shoulders.

The upper end of the body presents a housing where the end part of the neck can be precisely accommodated and mounted in the playing position.

A pin through slotted hole joint system holds the neck in a way that will be firmly joined once the strings are mounted thanks to string tension pulling in the opposite direction of the junction fulcrum.

The neck presents a T hammer bolt which come off its back and that slides into a slotted hole on a rigid plate positioned on the back of the body.

This junction pulls the neck in the opposite direction from the string tension, so that, when the strings will be mounted, the neck will be firmly joined to the body in its defined playing position.

In addition to this, the fingerboard can be unmounted in two parts: the junction point coincides near the end of the neck. This is a significant difference from other prior art instruments, because the fingerboard is one of the longest parts of the instrument making it impossible to split due to its necessity of being smooth and without any junction points. In the present invention, this is possible thanks to a rigid core in the neck, made up of a T bar specifically designed and shaped that slides into a dovetail slot on the final part of the fingerboard. These two parts are joined perfectly and tightly, and form a single unique piece, by a latch toggle clamp, positioned on the back face of the fingerboard.

Thus, this allows the instrument to be further disassembled, and occupy less space during transportation than any prior art instrument.

In preferred embodiment, the body is a wooden hollow acoustic chamber with a specifically designed shape made by two empty shells which meets each other on the outer outline edges, creating an enclosed resonating hollow space between them. Acoustic chamber can be obtained also joining together more than two elements, enclosing a hollow space into them, as is typically seen in most acoustic stringed musical instrument which use periphery element that extend between the first outer perimeter of the front face of the body (called soundboard) and the second outer perimeter of the back face of the body.

Its shape and its differently rounded faces give the instrument a strong, brilliant, rich, sustained, authentic acoustic sound, thanks also to the wood processing technique and geometrically perfected body wall thickness that make the entire instrument free to vibrate and to projecting the resonances of the soundboard.

The front face of the body (soundboard) presents six sound holes; additionally, there are two recessed slots, to house the bridge feet. These slots allow the musician to set the bridge in the same correct position every time, speeding and simplifying the mounting process.

The present invention incorporates an innovative and unique tool to further facilitate the bridge mounting and positioning. It is a shaped thin metal bar that works like a lever with a fulcrum at the tailpiece base where it needs to be pushed to be inserted. At the other extremity of the tool, the bridge is held flush to the soundboard, fastening the bridge during strings mounting and tuning. This is an additional positive innovation that contributes to make easier and faster the mounting and unmounting procedure of the instrument.

The familiar tailpiece is eliminated in the present invention: instead of anchoring the strings to the tailpiece, the strings are anchored to the body itself. At the bottom of the body, at its extremity, a wooden telescoping endpin is completely contained into instrument body.

The present invention is designed to provide the exact tactile and visual reference a trained double bassist requires for ease of performance: the invention is immediately playable and comfortable to anyone familiar with the traditional acoustic double bass. Thus, the invention is fitted with two collapsible shoulders that replicate the exact shape and outline of an acoustic double bass upper part. The musician can lean on them exactly like a classic double bass, maintaining the same tactile feeling. Like all the other parts of the invention, the two shoulders are designed to take up as little space as possible, and can be folded and placed easily in the specifically designed case, with all the other parts. The junction point with the body is in the same place of the neck and body junction, so that all the junctions on the body to other parts are hidden under a cap shaped in compliance with the body shape. The two shoulders have, at the extremity oriented to the body top, an L rigid plate with a keyhole slot by which the shoulders can be attached to the body on the suitable nailed head pins.

### BRIEF DESCRIPTION OF THE SEVERAL VIEWS OF DRAWINGS

FIGS. 1, 2, 3 are, respectively, the front, side and back view of the instrument mounted in its entirety.

FIG. 4 is a perspective view of the fingerboard mounting system which shows all the elements involved in the mounting system itself, while also shows a top and side view of the main element 2d.

FIG. 5 is a perspective view of the neck to body mounting system which shows all the elements involved in the system itself together with the elements involved in the neck inclination adjusting system.

FIGS. 6 and 7 are perspective view of the shoulder mounting system and features, respectively, while being mounted and when mounted.

FIG. 8 is a perspective exploded view of the screws and the elements which are needed to complete the assembly of all the parts connected with the body which are shoulders and neck.

FIG. 9 is a perspective view of how the endpin length adjustment works, with a balloon showing more in detail the hide mechanism which lock the endpin at the desired length.

### DESCRIPTION OF THE PREFERRED EMBODIMENT

Referring now to the figures in greater detail, where like reference numbers denote like parts in the various figures: the present invention will be described by way of an illustrative example (using a double bass).

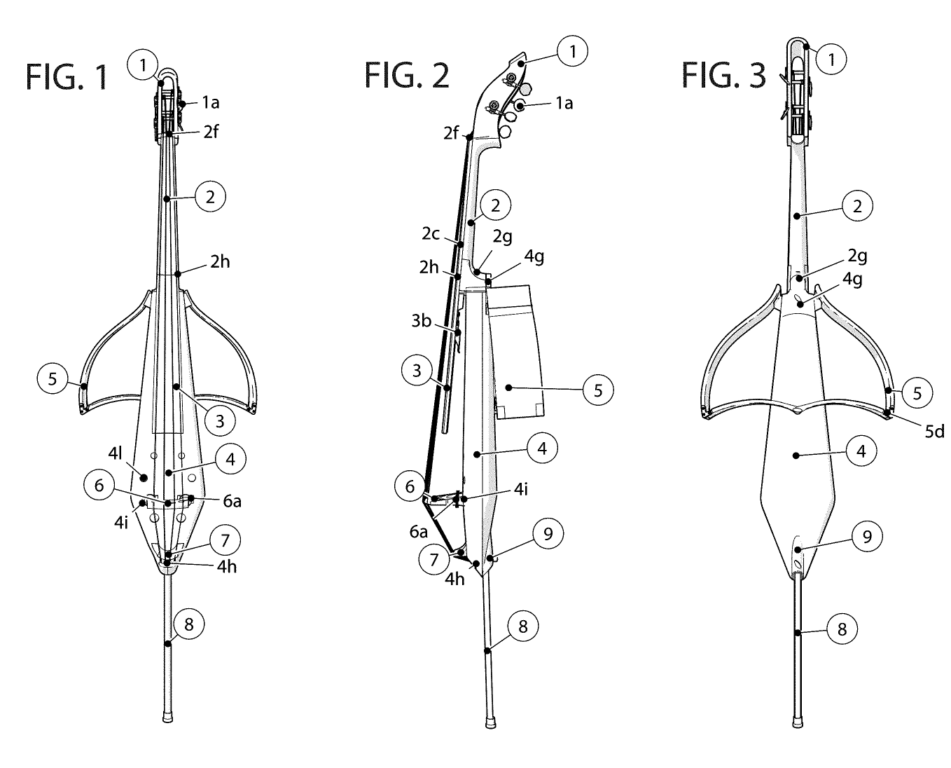

In FIGS. 1, 2 and 3 there is shown an electric upright double bass constructed in accordance with the present invention where you can see the main parts of the instrument, that will be described specifically at a later point, defined by circled callouts from 1 to 11.

Conventional tuning gears 1a are mounted on the head 1 of the instrument on the top of the neck 2 that run out on the body 4. The neck and the body can be easily disassembled, consistently with the intention of the present invention. The neck 2 is equipped with a fingerboard 3 that looks in shape and usability like a conventional ebony double bass fingerboard, except for the transverse cut that divides it in two parts, easily conjoining it without any junction point or step perceptible by touch. In this graphic presentation, for clarity, it is called fingerboard 3 only the part that can be dismantled from the entire fingerboard, considering the part in-built with the neck 2 as part of the neck itself. A plurality of playing strings are stretched out from the string rent 4h on the lowest part of the body 4 passing over the tailpiece 7 and the bridge 6, up to the nut 2f ending on the tuning gears 1a hub. It will be clearly understood that the number of strings arranged along the neck and the body portions depends on whether four, five or other type string arrangement is desired.

The present string musical instrument further includes a piezoelectric bridge 6 pickup with adjustment wheels 6a, that allow adjustment of the bridge 6 height by turning them. The bridge is held against the body 4 by the tension of the strings in a direction transversal to the longitudinal axis of the neck 2 and roughly equidistant from the end of the fingerboard 3 and string tailpiece, precisely in two slots 4i on the body that house perfectly the bridge feet, to ensure the ideal positioning whenever it is placed for strings mounting.

The preferred embodiment according to the present invention shows the body 4 as a wooden hollow acoustic chamber with a specifically designed shape. In the present invention, the hollow body 4 is made by two parts, the front face (called soundboard) and the back face, attached together and shaped as empty shells which meet each others on their respective perimeter, or border. The spatial arrangement between the soundboard and the back face define the acoustic chamber 4 which has a substantial impact on the characteristics of the sound produced by the stringed instrument.

Acoustic chamber can be obtained also combining together more than two elements, enclosing a hollow space into them, as is typically seen in most acoustic stringed musical instrument which use periphery element that extend between the first outer perimeter of the soundboard and the second outer perimeter of the back face of the body.

As such, deformations or imperfections in the acoustic chamber 4 can have a negative impact on the sound produced by the musical instrument, and, as well, a unadulterated acoustic chamber, with a specific inner thickness and a geometrically perfect surfaces can improve the sound quality of the instrument itself.

In the present invention, the body 4 shape and its differently rounded faces give the instrument a strong, brilliant, rich, sustained, authentic acoustic sound, also thanks to wooden processing technique and geometrically perfect body wall thickness that make the entire instrument free to vibrate.

The front face of the body (soundboard) presents six sound holes 4l. The hollow body also permits the entire containment of the endpin 8 when the instrument is dismounted for transportation. The endpin 8 slides in and out of the body 4 through a specific hole 9 on the bottom of the back side of the body 4. The endpin housing 9 is equipped with a mechanical locking system that permits the user to set the preferred length of the endpin 8 extends out of the body 4.

An important feature of the present invention is the two foldable shoulders 5 attached to the upper back part of the body 4, providing the correct overall balance and the proper player-to-instrument contact. As shown in FIGS. 1 and 3, the shoulders 5 substantially replicate the shape and the outline of the top portion of the traditional acoustic double bass body extending out from the body 4 laterally and backward. They make contact with the player body in the proper playing position, giving him the same feeling on the instrument as on a traditional double bass, replicating the exact tactile and visual references a trained double bassist requires for ease of performance: the invention is immediately playable and comfortable to anyone familiar with the traditional acoustic double bass.

The shoulders 5 are removable and mounted on the back of the body 4, near the neck-body junction, exactly in the portion defined in FIG. 3 by the junction cover 4g, that covers the junction and holds static all the joint parts involved, without play and vibrations.

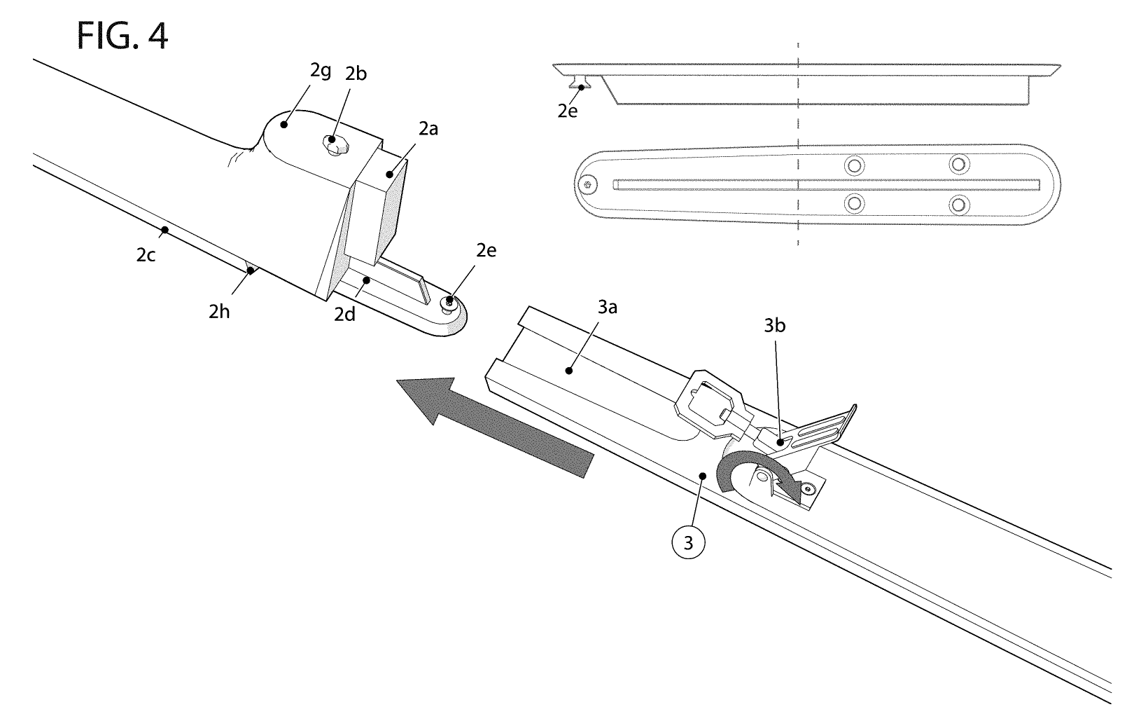

Referring now to the FIGS. 4, 5, 6, 7, 8 and 9 the present invention will be described more specifically in every constructive detail following the assembly steps needed to bring the invention to its playable position, consistently with one of its main feature: the disassembly system that allows it to occupy the smallest space possible.

As shown in FIG. 4 the fingerboard 3 can be unmounted from the neck 2, separating it from the neck fingerboard portion 2c. The neck 2 is equipped with a rigid core fixed to the fingerboard portion 2c and it works as a support for the two divided parts of the original fingerboard. In the preferred embodiment of the present invention, this rigid core support is made up of a t bar 2d with a specifically designed shape. In the present invention the t bar 2d is made of aluminum or like material that satisfies the needed resistance needed to support the fingerboard 3 junction. The t bar 2d is a rigid plate of thickness less than the fingerboard 3 thickness, it is presented as a rounded rectangle with a tapered bottom half from the middle to the end, it's oriented lengthwise to the neck 2 with the smallest radius extremity pointed towards the end part of the neck 2. Tapered bottom has circa 1.4 degree taper angle, which is the perfect declivity to allow the rigid bar 2d to slide in and out from the same shaped recess 3a on the fingerboard 3 easily and effortless, but also different taper angle may works as well.

The height of the reinforcement ribbing is completely inserted in the neck 2, while the plate is covered by the neck fingerboard portion 2c from the extremity with the biggest radius to the beginning of the tapered portion that protrudes out of the end of the neck 2a. The edge of the plate 2d is entirely chamfered at 45°, to be perfectly fitted into the dovetail slot 3a in a univocal orientation without play and imprecisions. To assemble the fingerboard 3 with the neck fingerboard portion 2c it is necessary to slide the shaped t bar 2d inside the fingerboard 3 along the dovetail slot 3a as deep as possible by hand, or until the hook of the latch toggle clamp 3b, fixed to the back side of fingerboard 3, can reach the pin 2e positioned on the plate 2d in proximity to the smallest radius extremity. Clasped the pin, it is sufficient to push down the latch toggle clamp 3b lever, which consequently pull the hook backward to the fingerboard 3 end extremity, but, being the hook blocked by the pin 2e, the result is that the fingerboard 3 is dragged toward the neck fingerboard portion 2c following the path defined by the dovetail slot 3a until the two fingerboard parts 3 and 2c meet each other joining perfectly and tightly at the transverse cut 2h in a single whole piece, as the standard stringed instrument fingerboard which it was before the cut.

This junction is extremely stable and strong so that, together with the specifically designed transverse cut 2h, which split the original standard fingerboard perpendicularly to its length, doesn't show any kind of step or junction point perceptible by touch. This important feature allows the musicians to disassemble the fingerboard in two parts for easy transportation, without any negative tactile feedback on the fingerboard when it is be re-assembled for play.

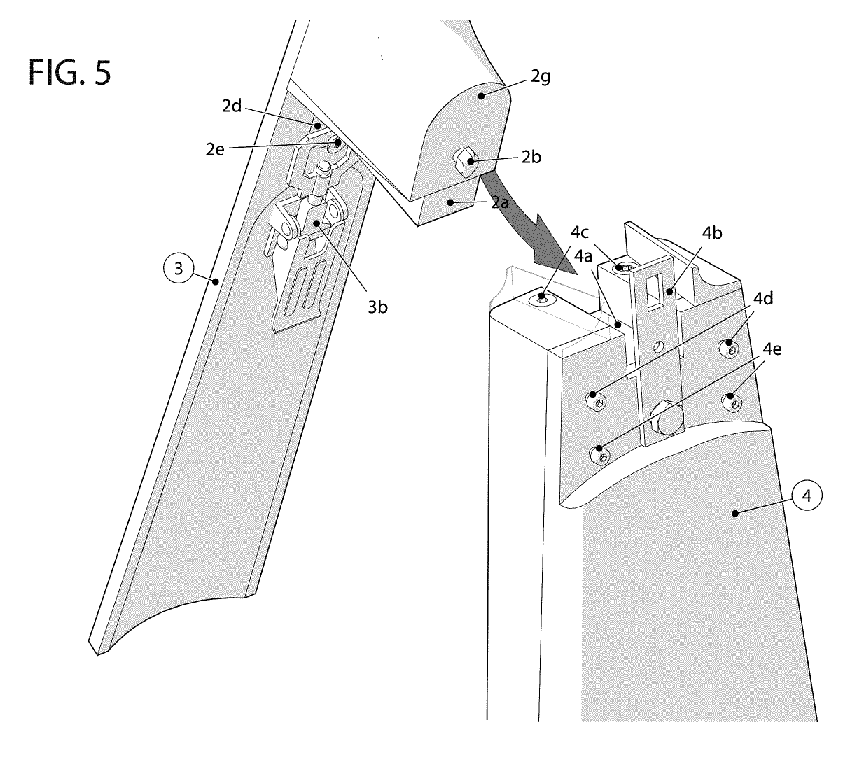

After having carefully described the fingerboard juncture, FIG. 5 shows the way to assemble the whole neck 2 (including the fingerboard 3) with the body 4 and all the correlated features.

The upper end of the body presents a housing 4a that works as a lane, through the front and the back face of the body, where the end part of the neck 2a can be precisely accommodated and the neck 2 mounted in the playing position.

The joint is essentially composed by a male part 2a, positioned under the back button 2g of the neck, precisely shaped to be housed into the slot 4a on the body 4.

The neck presents a T hammer bolt 2b which come off its back 2g and that slides into a slotted hole 4f on a rigid plate 4b positioned on the back of the body. Tilting slightly backward the neck 2, the t hammer bolt 2b head can pass through the slotted hole 4f and then it clasp the neck 2 to the plate 4b once the neck 2 is tilted back to the front, in playing position. At this point, the neck 2 is limited from tilt towards the front beyond the defined played position by the resistance of the t hammer bolt 2b against the rigid plate 4b. In addition to this, the strings tension pulls the neck 2 towards the front, limiting the neck 2 from tilt backward, so that, when the strings are mounted, the neck 2 is firmly joined to the body 4 because is limited to tilt towards the front by the rigid plate 4b and, at the same time, limited by the strings tension to tilt backward.

Back button 2g underside faces lean against the top horizontal face of the body, where there are two little neck grade adjustment screws 4c that can be screwed in or out equally to adjust the grade of the neck 2 forward and backward respect of the headstock orthogonal projection, or, unequally to also adjust the grade of the neck either towards the left or the right with respect to lengthwise centerline of the instrument, by changing the support points of the back bottom 2g. These adjustment of the grade of neck 2 have an impact on the distance of the strings from the fingerboard 3 which, thanks to this adjustment system, the user is able to adjust at his own preference before mounting the instrument and that will be stable along every assembly.

This locking system allows the user an easy and quick neck assembly on the body with an accurate grade adjustment and a robust fastening.

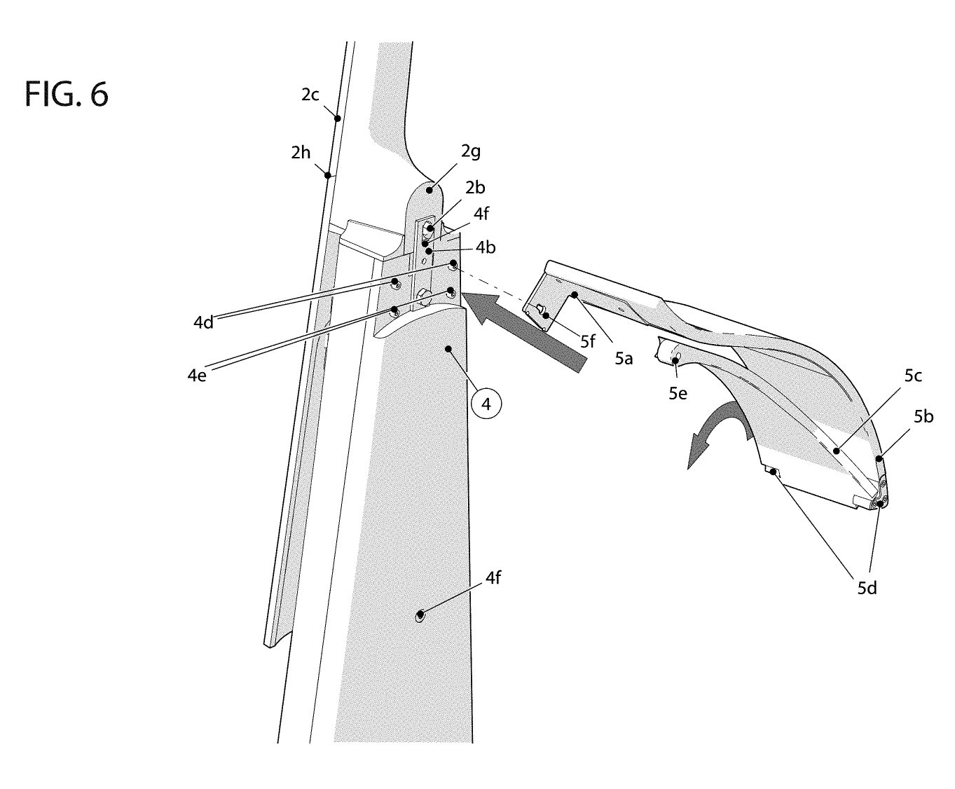

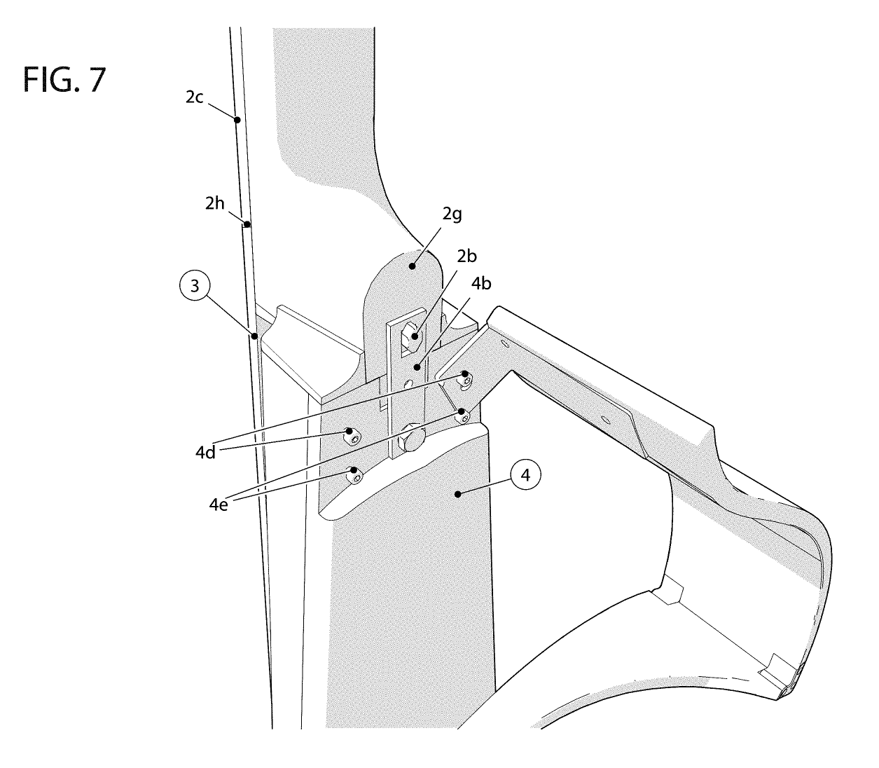

As described before, the present invention is fitted with two collapsible shoulders 5 that replicate the exact shape and outline of an acoustic double bass top portion of the body, as you can see in FIGS. 6 and 7. The shoulders are composed by an upper part 5b, that replicate the outline of an acoustic double bass body, and a lower part 5c that connects both the shoulders 5 to each other and to the body 4 with a thread sleeve 4f on the body back side by a threaded knob. The upper 5b and lower shoulder parts 5c are joined with two hinges 5d specifically designed and shaped to outline the shoulders 5 edges. In spite of their function being for support only, the shoulders lower part 5c matches the curvature of the upper part 5b of the same shoulder, to allow them to be folded over themselves through hinges 5d occupying the smallest space possible when in transportation arrangement.

To join the shoulders 5 to the body 4, the upper part of the shoulders 5b is equipped with an L plate 5a positioned with the longest face on the upper extremity of the upper part of the shoulder 5b parallel to the width of the shoulder itself. The smallest face of the L plate 5a presents a keyhole slot 5f profiled to let upper juncture pin 4d pass through it and clasp the shoulders 5 to the body. Inside the neck/body/shoulders join area, that is defined by the area that can be covered by the cover 4g, there are also two further juncture pins 4e, below the upper ones, that have the function of blocking the rotation of the shoulders inwards, that rotate around the upper juncture pins 4d towards the center of the body. These lower juncture pins 4e are housed into a small semi-circular hole on the edge of the L plate 5a, limiting its rotation.

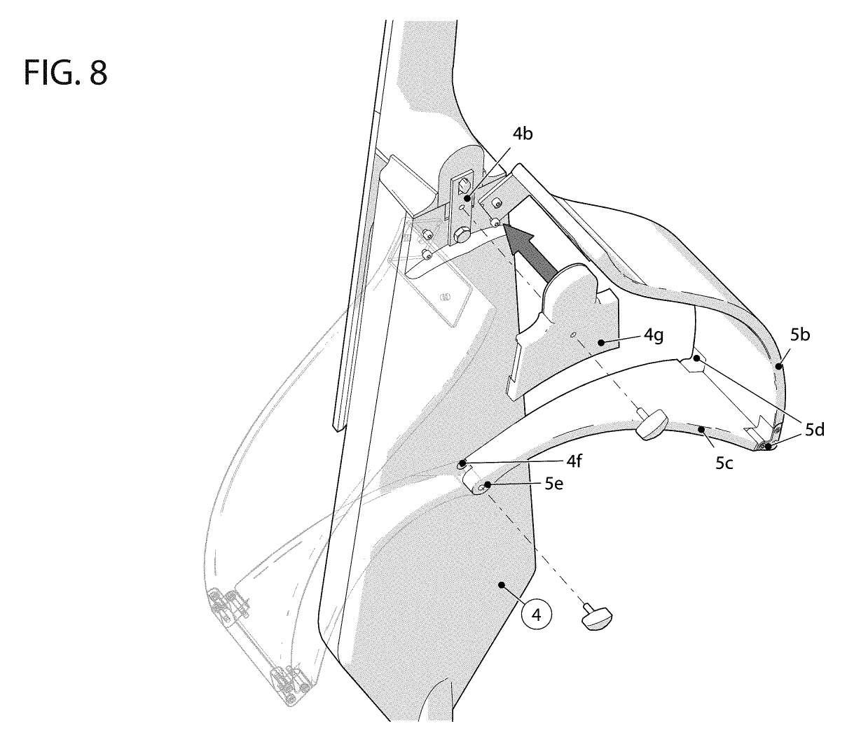

As showed in FIG. 8, when the shoulders 5 are correctly assembled on the body 4, as described above, the shoulders lower parts 5c can be unfolded to the limit imposed by the mechanical stop of the hinges 5d and the junction holes 5e, positioned on the extremity of the shoulder lower parts 5c, which are centered on each other with the thread sleeve 4f and fixed to the body 4 with the threaded knob.

Now the neck/body/shoulders join area can be covered by the cover 4g specifically shaped to outline the area, and fit with a soft vibration absorbing surface in the inner face to block all the juncture parts and to eliminate every possible vibration in that area, by squeezing against the area and by locking the cover with a threaded knob screwed in the threaded specific hole located in the middle of the plate 4b.

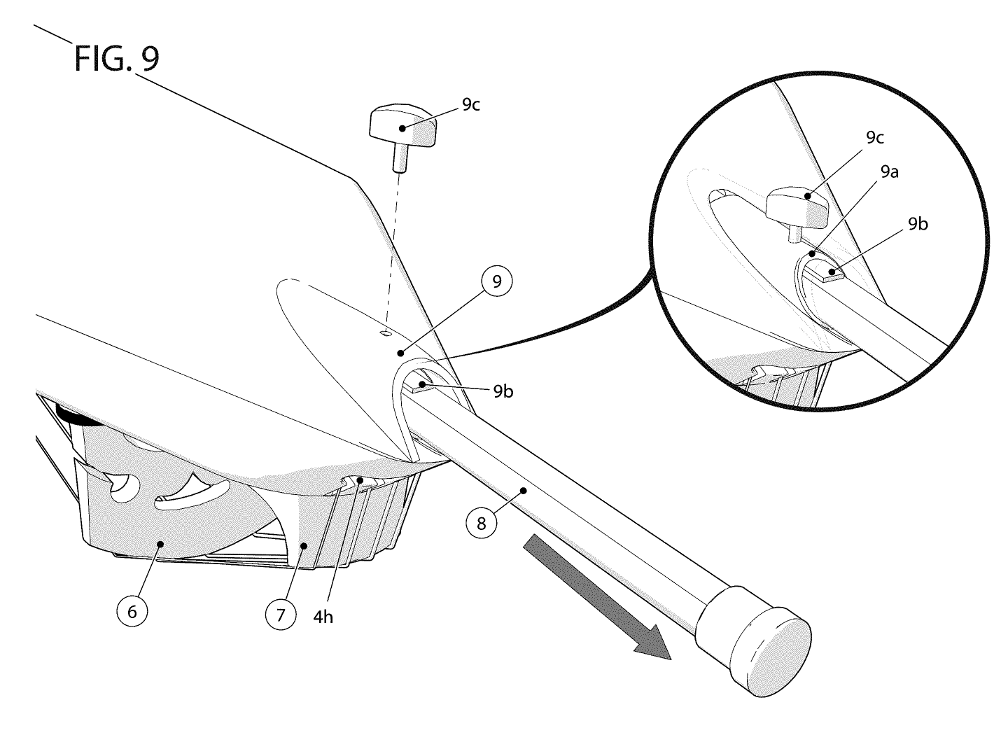

In FIG. 9 is showed the locking system to lock the endpin 8 in the preferred length out of the body 4. In the present invention, the endpin 8 is not a stringed musical instrument standard endpin. It is specifically designed with a material which is allowed to be board on plane (unlike the standard metal endpin), and also, it is not perfectly cylindrical: it has a flat surface narrower than the endpin 8 diameter itself.

On the back side of the body, on its bottom extremity there is positioned the endpin housing 9 that covers the inner housing pipe 9a that has the function of housing the endpin 8 in the correct angle and direction to let it be retracted properly inside the body 4 and drawn out in the correct position to ensure necessary instrument balance while playing. The pipe 9a presents a threaded hole perpendicular to its length that correspond to the hole on the endpin housing 9. Screwing in the endpin clamping knob 9c through the threaded hole on the inner pipe 9a, the threaded bar of the knob 9c pushes against the clamping bar 9b, contained inside the inner pipe 9a, consequently pushing against the flat face of the endpin 8, locking it in the preferred position, to avoid any possible sliding of the endpin 8 inside the body 4 under the weight of the instrument and the load of the musician in the playing position. The endpin 8 is fit with a non-slip tip 8a at its extremity that avoids the sliding of the instrument on the floor during the musician's performance.

I claim:

1. A foldable stringed musical instrument which comprising:
(a) a body consists of two parts shaped as half empty shell that meets each other on their outer perimeter, wherein these two parts together define a sound chamber;
(b) a couple of elements, not necessarily identical or symmetrical each other, dismountable from the body wherein these elements protrude out from the outline of the body appointed to serve as a stable support for the user while using the instrument;
(c) a neck dismountable from the body having a bottom portion configured for coupling to a top portion of the body, the neck is able to be mounted in the playing position and locked by the instrument's plurality of strings tension;
(d) a splitted playable fingerboard that can be disassembled and reassembled in two or more parts of itself to ease storage and transportation;

2. Two elements as said as a couple in claim 1 which are designed to be folded two or more times on themselves to reduce them encumbrance when dismounted.

3. A mounting and joining system between neck and body elements as said in claim 1 that are operatively connected to merge together in correct instrument playing position, that works by:
(a) providing said neck and body with reciprocally corresponding male and female shaped parts at the final extremity for each one, where final extremity is the one which faces to the element which is joining with.
(b) inserting the said male part of one of the two elements into the corresponding female part belonging to the other element the two elements are both limited by each other to move or tilt laterally.
(c) providing a mechanical junction which hold the back side of the said neck extremity close to or coincident with the back side of the body limiting the neck to tilt forward.
(d) the instruments strings pull the neck forward limiting the neck to tilt backward and holding the neck stable in playing position.

4. The invention of claim 3 is a female slot on the top of the body where the shaped male parts of the extremity of the neck can slide into until the neck back face, which is provided with a pin, meets a rigid plate joined with the body back face which is provided with a slotted hole to house the said pin in a stable way.

5. The said pin of claim 4 is a T hammer bolt.

6. The invention of claim 3 further comprising a neck inclination adjustment system that works by:
(a) providing the neck support area, wherein the support area is defined by the surface of contact between the two said elements neck and body, with one or more functional elements which can be protruded out at will from the support area surface level at different heights;
(b) adjusting the height of these elements out from the support area surface the contact points between the neck and the body are going to change, modifying the initially flat supporting area in a inclined plane which, consequentially, modify the neck inclination in accordance with one's own preferences.

7. The invention of claim 6 are two threaded pins screwed on the support area surface until the top goes below the support area surface which can be unscrewed at will to protrude them beyond the support area surface flat level.

8. A playable fingerboard which can be splitted, and then re-assembled, in two or more parts to ease storage and transportation which comprising:
(a) a rigid elongated element placed on fingerboard surface or inside it crossing the fingerboard cutted points and which works as a trail to allows the different parts of the fingerboard to perfectly meet each other and to enforce the fingerboard on its junction points;
(b) a latch to hold all the fingerboard parts merged together.

9. The said latch of claim 8 is a latch toggle clamp which is placed on a portion of the cutted fingerboard to grab and pull the other corresponding fingerboard portion holding them strictly merged.

10. The said rigid element of claim 8 is a profiled rigid plate which is housed into the fingerboard through a slot on the fingerboard with zero clearance which extend from the portion of fingerboard before the cut to the portion after the cut.

11. The invention of claim 10 is a rigid plate of thickness less than the fingerboard thickness profiled as a rounded rectangle with chamfered edges with a tapered bottom half from the middle to the end and it is oriented lengthwise to the fingerboard.

12. The said fingerboard slot of claim 10 is a dovetail slot shaped to fit with zero clearance the shape and the profile of the invention of claim 11.
